(19) United States
(12) Patent Application Publication
(10) Pub. No.: US 2010/0144585 A1
(43) Pub. Date: Jun. 10, 2010

(54) FABRIC SOFTENING COMPOSITIONS COMPRISING SILICONE COMPRISING COMPOUNDS

(76) Inventors: Nilgün Esin AKSOY, Strombeek-Bever (BE); Andreas Leopold, Merchtem (BE); Olivier Roman Oscari, Brussel (BE); Vincenzo Tomarchio, Bruxelles (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/634,781

(22) Filed: Dec. 10, 2009

(30) Foreign Application Priority Data
Dec. 10, 2008 (EP) 08171197.0

(51) Int. Cl. C11D 3/20

(52) U.S. Cl. 510/527; 510/515

(57) ABSTRACT

The present invention relates to a fabric softening composition which maintains physical stability upon freeze-thaw.

### FIELD OF INVENTION

The present invention relates to fabric softening compositions comprising silicone comprising compounds, which are physically stable at low temperatures.

### BACKGROUND TO THE INVENTION

Conventional fabric softening compositions are added in the rinse cycle of the laundering process to soften fabrics. While pleasant fabric-feel is the main motivation for consumers to use fabric softening compositions, it is also known that products demonstrating good pourability, dispersibility, dispensability and storage stability at different temperatures are desired by consumers.

It is difficult to obtain a fabric softener composition that meets consumer fabric feel needs and remains physically stable upon exposure to cold temperatures. Physical instability, can manifest itself as a thickening or gelling of the composition following a freeze-thaw cycle and/or upon prolonged storage of the composition at low temperature. Gelling, or thickening of the product results in poor dispersibility into the wash liquor, uneven deposition onto fabrics, spotting, and potentially sticking of residual composition to the washing machine dispenser drawer.

Prior art fabric softeners typically contain non-ionic surfactants and polyols to address the physical stability needs of products that are exposed to low temperatures. The use of polyols to prevent freezing and hence aid in the physical stability of fabric softening compositions is described in WO2006/124338, wherein more than 5% and up to 50% of the weight of the composition is a polyol.

In such formulations, the manufacturer is forced to allocate a significant part of the formulation cost into the incorporation of high levels of polyols; ensuring product stability. Subsequently, using such high levels of polyol, results in the overall formulation cost being very much dependent on the pricing of polyols. An alternative freeze resistant system would, therefore, allow manufacturers to invest in a more consumer relevant benefit for fabric softeners, such as softener active or perfume.

There is a need in the art to provide a fabric softening composition that can maintain physical stability following a freeze-thaw cycle and that is physically stable upon prolonged storage at low temperatures, but which uses lower concentrations of polyols than traditional freeze-resistant fabric softening compositions. In addition, there is a need in the art to provide a fabric softening composition that can maintain physical stability following a freeze-thaw cycle and that is physically stable upon prolonged storage at low temperatures and also provides excellent softening properties.

It has been surprisingly found that silicone comprising compounds help maintain the physical stability of the fabric softening compositions following freeze-thaw cycles, minimizing the amount of polyol required. They also help maintain the physical stability of the fabric softening composition upon prolonged storage at low temperatures. In addition, as well as helping maintain the physical stability of the fabric softening composition following a freeze-thaw cycle and upon prolonged storage at low temperatures, silicone comprising compounds provide an excellent fabric softening benefit.

### BRIEF DESCRIPTION OF THE DRAWINGS

FIGS. 1 and 2 show decrease in viscosity of fabric softener compositions of the present invention after freeze-thaw cycling as the silicone comprising compound levels increase. FIG. 1 shows this positive impact of silicone comprising compounds on viscosity with increasing numbers of freeze-thaw cycles. FIG. 2 shows this same positive impact of silicone comprising compounds, but this time in the presence of different fabric softener concentrations.

### SUMMARY OF THE INVENTION

One aspect of the present invention is a fabric softening composition comprising, a fabric softening active, 0.5% to 10% by weight of the fabric softening composition of a silicone comprising compound, wherein the silicone comprising compound is polydimethyl silicone, 0.005% to 4% by weight of the fabric softening composition, of a non-ionic alkoxylated surfactant, and 0.005% to 15% by weight of the fabric softening composition, of a polyol.

Another aspect of the present invention, is the use of a composition comprising, a fabric softening active, 0.5% to 10% by weight of the fabric softening composition of a silicone comprising compound, wherein the silicone comprising compound is polydimethyl silicone, 0.005% to 4% by weight of the fabric softening composition of a non-ionic alkoxylated surfactant, and 0.005% to 15% by weight of the fabric softening composition of a polyol, as a composition that when tested immediately following a freeze-thaw cycle comprising a first step at −18° C. for 24 hours followed by a second step at +20° C. for 24 hours, has a viscosity of less than 0.5 m⁻¹. kg.s⁻¹.

Another aspect of the present invention, is the method of use of a composition comprising, a fabric softening active, 0.5% to 10% by weight of the fabric softening composition of a silicone comprising compound, wherein the silicone comprising compound is polydimethyl silicone, 0.005% to 4% by weight of the fabric softening composition of a non-ionic alkoxylated surfactant, and 0.005% to 15% by weight of the fabric softening composition of a polyol, comprising the step of dosing the composition in a rinse step of a washing process.

### DETAILED DESCRIPTION OF THE INVENTION

By “physical stability” we herein mean maintenance of commercially acceptable viscosity. In the context of the present invention a commercial acceptable viscosity is below 0.5 m⁻¹. kg.s⁻¹.

By “freeze-thaw cycle” we herein mean 0.175 l of the fabric softening composition of the present invention is exposed to one or more cycles of a first step at −18° C. for 24 hours followed by a second step of +20° C. for 24 hours.

By “low temperature” we herein mean temperatures less than +20° C. By “prolonged storage stability at low temperature” we herein mean storage at a temperature below +20° C., for up to 2 months, at which the physical stability of the fabric softening composition is not compromised.

### 1. Fabric Softener Active

In the context of the present invention, any suitable fabric softener actives can be used. Preferably, the fabric softener active is selected from the group comprising, diester quaternary ammonium compounds, dialkyl quaternary ammonium compounds, imidazolinium quaternary compounds, cationic starch, sucrose ester-based fabric care materials, and mixtures thereof.

A first preferred type of fabric softening active comprises, as the principal active, compounds of the formula

{R₄₋ₘ—N⁺—[(CH₂)ₙ—Y—R¹]ₘ}X⁻ (1)

wherein each R substituent is either hydrogen, a short chain C₁-C₆, preferably C₁-C₃ alkyl or hydroxyalkyl group, e.g., methyl, ethyl, propyl, hydroxyethyl, and the like, poly (C₂₋₃ alkoxy), preferably polyethoxy, benzyl, or mixtures thereof; each m is 2 or 3; each n is from 1 to about 4, preferably 2; each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group, and X⁻ can be any softener-compatible anion, preferably, chloride, bromide, methylsulfate, ethylsulfate, sulfate, and nitrate, more preferably chloride or methyl sulfate;

A second type of preferred fabric softening active has the general formula:

[R₃N⁺CH₂CH(YR¹)(CH₂YR¹)]X⁻

wherein each Y, R, R¹, and X⁻ have the same meanings as before. Such compounds include those having the formula:

[CH₃]₃N⁽⁺⁾[CH₂CH(CH₂O(O)CR¹)O(O)CR¹]Cl⁽⁻⁾ (2)

wherein each R is a methyl or ethyl group and preferably each R¹ is in the range of C₁₅ to C₁₉. As used herein, when the diester is specified, it can include the monoester that is present.

These types of agents and general methods of making them are disclosed in U.S. Pat. No. 4,137,180, Naik et al., issued Jan. 30, 1979. An example of a preferred DEQA (2) is the “propyl” ester quaternary ammonium fabric softener active having the formula 1,2-di(acyloxy)-3-trimethylammoniopropane chloride.

A third type of preferred fabric softening active has the formula:

[R₄₋ₘ—N⁺—R¹ₘ]X⁻ (3)

wherein each R, R¹, and X⁻ have the same meanings as before.

A fourth type of preferred fabric softening active has the formula:

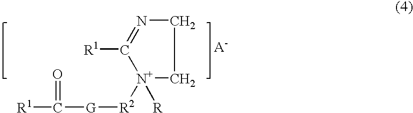

wherein each R, R¹, and A⁻ have the definitions given above; each R² is a C₁₋₆ alkylene group, preferably an ethylene group; and G is an oxygen atom or an —NR— group;

A fifth type of preferred fabric softening active has the formula:

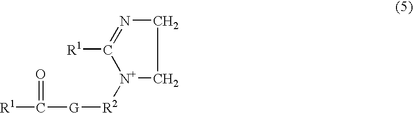

wherein R¹, R² and G are defined as above.

A sixth type of preferred fabric softening active are condensation reaction products of fatty acids with dialkylenetriamines in, e.g., a molecular ratio of about 2:1, said reaction products containing compounds of the formula:

R¹—C(O)—NH—R²—NH—R³—NH—C(O)—R¹ (6)

wherein R¹, R² are defined as above, and each R³ is a C₁₋₆ alkylene group, preferably an ethylene group and wherein the reaction products may optionally be quaternized by the additional of an alkylating agent such as dimethyl sulfate. Such quaternized reaction products are described in additional detail in U.S. Pat. No. 5,296,622, issued Mar. 22, 1994 to Uphues et al.

A seventh type of preferred fabric softening active has the formula:

[R¹—C(O)—NR—R²—N(R)₂—R³—NR—C(O)—R¹]⁺A⁻ (7)

wherein R, R¹, R², R³ and A⁻ are defined as above;

An eighth type of preferred fabric softening active are reaction products of fatty acid with hydroxyalkylalkylenediamines in a molecular ratio of about 2:1, said reaction products containing compounds of the formula:

R¹—C(O)—NH—R²—N(R³OH)—C(O)—R¹ (8)

wherein R¹, R² and R³ are defined as above;

A nineth type of preferred fabric softening active has the formula:

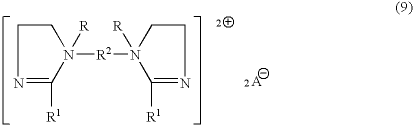

wherein R, R¹, R², and A⁻ are defined as above.

Non-limiting examples of compound (1) are N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl)N-methyl ammonium methylsulfate.

Non-limiting examples of compound (2) is 1,2 di(stearoyl-oxy) 3 trimethyl ammoniumpropane chloride.

Non-limiting examples of Compound (3) are dialkylenedimethylammonium salts such as dicanoladimethylammonium chloride, di(hard)tallowdimethylammonium chloride dicanoladimethylammonium methylsulfate,. An example of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel Arquad 2HT75.

A non-limiting example of Compound (4) is 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Witco Corporation under the trade name Varisoft®.

A non-limiting example of Compound (5) is 1-tallowylamidoethyl-2-tallowylimidazoline wherein R¹ is an acyclic aliphatic C₁₅-C₁₇ hydrocarbon group, R² is an ethylene group, and G is a NH group.

A non-limiting example of Compound (6) is the reaction products of fatty acids with diethylenetriamine in a molecular ratio of about 2:1, said reaction product mixture containing N,N″-dialkyldiethylenetriamine with the formula:

R¹—C(O)—NH—CH₂CH₂—NH—CH₂CH₂—NH—C(O)—R¹

wherein R¹—C(O) is an alkyl group of a commercially available fatty acid derived from a vegetable or animal source, such as Emersol® 223LL or Emersol® 7021, available from Henkel Corporation, and R² and R³ are divalent ethylene groups.

A non-limiting example of Compound (7) is a difatty amidoamine based softener having the formula:

[R¹—C(O)—NH—CH₂CH₂—N(CH₃)(CH₂CH₂OH)—CH₂CH₂—NH—C(O)—R¹]⁺CH₃SO₄⁻

wherein R¹—C(O) is an alkyl group, available commercially from the Witco Corporation e.g. under the trade name Varisoft® 222LT.

An example of Compound (8) is the reaction products of fatty acids with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is an alkyl group of a commercially available fatty acid derived from a vegetable or animal source, such as Emersol® 223LL or Emersol® 7021, available from Henkel Corporation.

An example of Compound (9) is the diquaternary compound having the formula:

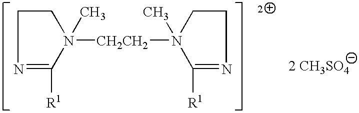

wherein R¹ is derived from fatty acid, and the compound is available from Witco Company.

It will be understood that combinations of softener actives disclosed above are suitable for use in this invention.

### Anion A

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

### Cationic Starch

One aspect of the present invention provides a cationic starch as a fabric softening active.

The term “cationic starch” is used herein in the broadest sense. In one aspect of the invention, cationic starch refers to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. See Solarek, D. B., Cationic Starches in Modified Starches: Properties and Uses, Wurzburg, O. B., Ed., CRC Press, Inc., Boca Raton, Fla. 1986, pp 113-125.

In one embodiment, the compositions of the present invention generally comprise cationic starch at a level of from 0.1% to 7%, alternatively from 0.1% to 5%, alternatively from 0.3% to 3%, alternatively from 0.5% to 2%, alternatively from 0.01% to 5%, and alternatively from 0.3% to 2%, by weight of the composition. Cationic starch is described in U.S. Pat. Pub. 2004/0204337 A1, published Oct. 14, 2004, to Corona et al., at paragraphs 16-32.

### Sucrose Ester-Based Fabric Care Materials

In one embodiment, the compositions of the present invention may comprise a sucrose ester-based fabric care material is a fabric softening active. A sucrose ester may be composed of a sucrose moiety having one or more of its hydroxyl groups esterified.

Sucrose is a disaccharide having the following formula:

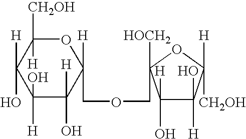

Alternatively, the sucrose molecule can be represented by the formula: M(OH)₈, wherein M is the disaccharide backbone and there are total of 8 hydroxyl groups in the molecule. Thus, sucrose ester can be represented by the following formula:

M(OH)₈₋ₓ(OC(O)R¹)ₓ

wherein x of the hydroxyl groups are esterified and (8-x) hydroxyl groups remain unchanged; x is an integer selected from 1 to 8, or from 2 to 8, or from 3 to 8, or from 4 to 8; and R¹ mioeties are independently selected from C1-C22 alkyl or C1-C30 alkoxy, linear or branched, cyclic or acyclic, saturated or unsaturated, substituted or unsubstituted.

In one embodiment, the R¹ moieties comprise linear alkyl or alkoxy moieties having independently selected and varying chain length. For example, R¹ may comprise a mixture of linear alkyl or alkoxy moieties wherein greater than about 20% of the linear chains are C18, or greater than about 50% of the linear chains are C18, or greater than about 80% of the linear chains are C18.

In another embodiment, the R¹ moieties comprise a mixture of saturate and unsaturated alkyl or alkoxy moieties; the degree of unsaturation can be measured by “Iodine Value” (hereinafter referred as “IV”, as measured by the standard AOCS method). The IV of the sucrose esters suitable for use herein ranges from about 1 to about 150, or from about 2 to about 100, or from about 5 to about 85. The R¹ moieties may be hydrogenated to reduce the degree of unsaturation.

In a further embodiment, the unsaturated R¹ moieties may comprise a mixture of “cis” and “trans” forms about the unsaturated sites. The “cis”/“trans” ratios may range from about 1:1 to about 50:1, or from about 2:1 to about 40:1, or from about 3:1 to about 30:1, or from about 4:1 to about 20:1.

In another embodiment, the composition comprises an olyhydroxy material or sugar derivative. Polyhydroxy amide structures as disclosed in U.S. Pat. No. 5,534,197 by Scheibel et al. and U.S. Pat. No. 5,512,699 by Connor et al.; Pentaerythritol compounds and derivatives as disclosed in U.S. Pat. No. 6,294,516 at column 4 lines 1-48; cyclic polyols and/or reduced saccharides as disclosed in U.S. Pat. No. 6,410,501.

### Adjunct Fabric Softening Actives

The fabric softening compositions of the present invention may comprise adjunct fabric softening actives. These actives may include one or more of the following; clays as described in U.S. Pat. Pub. No. 2004/0142841 A1, published Jul. 22, 2004, de Buzzacarini et al., from paragraphs 74-99; fats and/or fatty acids disclosed in U.S. Pat. Pub. No. 2006/0122087; polyhydroxy amide structures as described in U.S. Pat. No. 5,534,197 by Scheibel et al. and U.S. Pat. No. 5,512,699 by Connor et al.; Pentaerythritol compounds and derivatives thereof as disclosed in U.S. Pat. No. 6,294,516 at column 4 lines 1-48; and cyclic polyols and/or reduced saccharides as disclosed in U.S. Pat. No. 6,410,501.

In one embodiment, the composition of the present invention comprises from 0.001% to 10% of an adjunct fabric softening active. In another embodiment, the compositions are free or essentially free of one of the aforementioned adjunct fabric softening actives.

In the present invention, the fabric softening active is present from 2% to 30%, preferably from 4% to 20% and most preferably from 5% to 15% by weight of the fabric softening composition.

### 2. Silicone Comprising Compounds

The composition of the present invention comprises a silicone comprising compound which acts to maintain the physical stability of the fabric softening composition following a freeze-thaw cycle and also upon prolonged storage at low temperatures.

The silicone comprising compound of the present invention is polydimethyl silicone. In one embodiment, the silicone comprising compound of the present invention can be any silicone comprising compound. Preferably, it is selected from the group comprising non-ionic nitrogen free silicone comprising compounds, aminofunctional silicone comprising compounds and mixtures thereof.

In one embodiment of the present invention, the silicone comprising compound is an aminofunctional silicone, preferably amodimethicone.

In a preferred embodiment of the present invention, the silicone comprising compound is a non-ionic nitrogen free silicone comprising compound, preferably, selected from the group comprising polydialkyl silicone, polydimethyl silicone, alkyloxylated silicone, ethoxylated silicone, propoxylated silicone, ethoxylated propoxylated silicone, quaternary silicone or derivatives thereof and mixtures thereof. In a more preferred embodiment, the non-ionic nitrogen free silicone comprising compound is selected from the group comprising polydialkyl silicone, polydimethyl silicone and mixtures thereof. The silicone comprising compound of the present invention is polydimethyl silicone.

In this preferred embodiment, wherein the silicone comprising compound is polydimethyl silicone, the polydimethyl silicone has a viscosity between 0.0001 m².s⁻¹ and 0.1 m².s⁻¹, preferably between 0.0003 m².s⁻¹ and 0.06 m².s⁻¹, more preferably between 0.00035 m².s⁻¹ and 0.012 m².s⁻¹.

The silicone comprising compound of the present invention is at a level from 0.5% to 10%. In another embodiment, the silicone comprising compound of the present invention is at a level from 0.3% to 10%, preferably from 0.3% to 5%, and most preferably from 0.5% to 3.0% by weight of the fabric softening composition.

I. Non-Ionic Nitrogen Free Silicone Comprising Compounds:

In the context of the present invention, preferably the silicone comprising compound is selected from the group comprising non-ionic nitrogen free silicone comprising compounds having the formulae (I), (II), (III), and mixtures thereof:

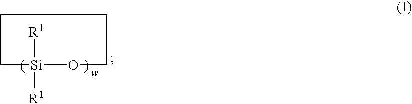

R²—(R¹)₂SiO—[(R¹)₂SiO]ₐ—[(R¹)(R²)SiO]_{b}—Si(R¹)₂—R² (II);

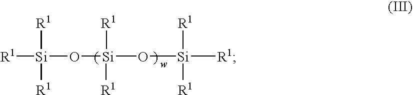

wherein each R¹ is independently selected from the group consisting of linear, branched or cyclic substituted or unsubstituted alkyl groups having from 1 to 20 carbon atoms; linear, branched or cyclic substituted or unsubstituted alkenyl groups having from 2 to 20 carbon atoms; substituted or unsubstituted aryl groups having from 6 to 20 carbon atoms; substituted or unsubstituted alkylaryl, substituted or unsubstituted arylalkyl and substituted or unsubstituted arylalkenyl groups having from 7 to 20 carbon atoms and mixtures thereof; each R² is independently selected from the group consisting of linear, branched or cyclic substituted or unsubstituted alkyl groups having from 1 to 20 carbon atoms; linear, branched or cyclic substituted or unsubstituted alkenyl groups having from 2 to 20 carbon atoms; substituted or unsubstituted aryl groups having from 6 to 20 carbon atoms; substituted or unsubstituted alkylaryl groups, substituted or unsubstituted arylalkyl, substituted or unsubstituted arylalkenyl groups having from 7 to 20 carbon atoms and from a poly(ethyleneoxide/propyleneoxide) copolymer group having the general formula;

—(CH₂)ₙO(C₂H₄O)_{c}(C₃H₆O)_{d}R³ (IV)

polydialkyl silicone, polydimethyl silicone, alkyloxylated silicone, quaternary silicone with at least one R² being a poly(ethyleneoxy/propyleneoxy) copolymer group (ethoxylated silicone, propoxylated silicone, ethoxylated propoxylated silicone comprising compounds), and each R³ is independently selected from the group consisting of hydrogen, an alkyl having 1 to 4 carbon atoms, an acetyl group, and mixtures thereof, wherein the index w has the value as such that the viscosity of the nitrogen-free silicone polymer of formulae (I) and (III) is between 0.0001 m².s⁻¹ (100 centistokes) and 0.1 m².s⁻¹ (100,000 centistokes); wherein a is from 1 to 50; b is from 1 to 50; n is 1 to 50; total c (for all polyalkyleneoxy side groups) has a value of from 1 to 100; total d is from 0 to 14; total c+d has a value of from 5 to 150.

More preferably, the non-ionic nitrogen free silicone comprising compound is selected from the group consisting of linear non-ionic nitrogen-free silicone comprising compounds having the formulae (II) to (III) as above, wherein R¹ is selected from the group consisting of methyl, phenyl, phenylalkyl, and mixtures thereof; wherein R² is selected from the group consisting of methyl, phenyl, phenylalkyl, and mixtures thereof; and from the group having the general formula (IV), as defined above, and mixtures thereof; wherein R³ is defined as above and wherein the index w has a value such that the viscosity of the nitrogen-free silicone comprising compound of formula (III) is between 0.0001 m².s⁻¹ (100 centistokes) and 0.1 m².s⁻¹ (100,000 centistokes); a is from 1 to 30, b is from 1 to 30, n is from 3 to 5, total c is from 6 to 100, total d is from 0 to 3, and total c+d is from 7 to 100.

Most preferably, the nitrogen-free silicone comprising compound is selected from the group comprising linear non-ionic nitrogen free silicone comprising compounds having the general formula (III) as above, wherein R¹ is methyl, i.e. the silicone comprising compound is polydimethyl silicone In this preferred embodiment, wherein the silicone comprising compound is polydimethyl silicone, index w has a value such that the polydimethyl silicone has a viscosity between 0.0001 m².s⁻¹ and 0.1 m².s⁻¹, preferably between 0.0003 m².s⁻¹ and 0.06 m².s⁻¹, more preferably between 0.00035 m².s⁻¹ and 0.012 m².s⁻¹.

### II. Aminofunctional Silicone Comprising Compounds:

In one embodiment of the present invention, the silicone comprising compound is an aminofunctional silicone. Aminofunctional silicone comprising compounds are materials of the formula:

HO[Si(CH₃)₂—O]ₓ{Si(OH)[(CH₂)₃—NH—(CH₂)₂—NH₂]O}_{y}H

wherein x and y are integers which depend on the viscosity of the silicone comprising compound. Preferably, the aminofunctional silicone comprising compound has a molecular weight such that it exhibits a viscosity of from 0.0005 m².s⁻¹ (500 centistokes) to 0.5 m².s⁻¹ (500,000 centistokes). This material is also known as “amodimethicone”. Although silicone comprising compounds with a high number of amine groups, e.g., greater than about 0.5 millimolar equivalent of amine groups can be used, they are not preferred because they can cause fabric yellowing.

### III. Silicone Comprising Compound Emulsions

In one embodiment, the silicone comprising compounds of the present invention are added as an emulsion of the silicone comprising compound in a solvent, wherein the solvent is preferably a non-aqueous solvent, more preferably an organic solvent, and even more preferably selected from the group comprising C1-C20 linear, branched, cyclic, saturated and/or unsaturated alcohols with one or more free hydroxy groups; amines, alkanolamines, and mixtures thereof. Preferred solvents are monoalcohols, diols, monoamine derivatives, glycerols, glycols, and mixtures thereof, such as ethanol, propanol, propandiol, monoethanolamin, glycerol, sorbitol, alkylene glycols, polyalkylene glycols, and mixtures thereof. Most preferred solvents are selected from the group comprising 1,2-propandiol, 1,3-propandiol, glycerol, ethylene glycol, diethyleneglycol, and mixtures thereof. In a preferred embodiment of the present invention, premixes comprising silicone comprising compounds and solvents are utilized in order to overcome process problems in terms of proper dispersion or dissolution of all ingredients throughout the composition.

In the context of the present invention, processing advantages are achieved by using a high internal phase emulsion (“HIPE”) as a premix. That is achieved by premixing a silicone comprising compound, such as polydimethyl silicone, and an emulsifier to create a HIPE, then mixing this HIPE into the composition, thereby achieving good mixing resulting in an homogeneous mixture. Such HIPEs are comprised of at least 65%, alternatively at least 70%, alternatively at least 74%, alternatively at least 80%; alternatively not greater than 95%, by weight of an internal phase (dispersed phase), wherein the internal phase comprises a silicone comprising compound. The internal phase can also be other water insoluble fabric care benefit agents that are not already pre-emulsified. The internal phase is dispersed by using an emulsifying agent. Examples of the emulsifying agent include a surfactant or a surface tension reducing polymer. In one embodiment, the range of the emulsifying agent is from at least 0.1% to 25%, alternatively from 1% to 10%, and alternatively from 2% to 6% by weight of the HIPE. In another embodiment, the emulsifying agent is water soluble and reduces the surface tension of water, at a concentration less than 0.1% by weight of deionized water, to less than 0.0007 N (70 dynes), alternatively less than 0.0006 N (60 dynes), alternatively less than 0.0005 N (50 dynes); alternatively at or greater than 0.0002 N (20 dynes). In another embodiment, the emulsifying agent is at least partially water insoluble.

The external phase (continuous phase), in one embodiment, is water, alternatively comprises at least some water, alternatively comprises little or no water. In another embodiment, the external phase of water comprises from less than 35%, alternatively less than 30%, alternatively less than 25%; alternatively at least 1%, by weight of HIPE. Non-aqueous HIPEs can be prepared as well with a solvent as the external phase with low or no water present. Typical solvents include glycerin and propylene glycol.

In another embodiment, the composition is a non-concentrated composition. In this embodiment, the silicone comprising compound is not, at least initially, emulsified and can be emulsified in the fabric care composition itself.

### 3. Non-Ionic Alkoxylated Surfactant

One aspect of the present invention provides for the addition of non-ionic alkoxylated surfactants in the composition from 0.05% to 5%, preferably from 0.1% to 2%, and most preferably from 0.2% to 1% by weight of the fabric softening composition. It should also be noted, that in the context of the present invention, non-ionic alkoxylated surfactant can also serve as an emulsifying agent for the silicone comprising compound as is described in the previous section. Suitable non-ionic alkoxylated surfactants for use herein include the alcohol alkoxylate non-ionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 20 ethylene oxide moieties per molecule, more preferably from about 3 to 18 ethylene oxide moieties per molecule, most preferably 4 to 10 ethylene oxide moieties per molecule.

### 4. Polyols

One aspect of the present invention provides for the addition of a polyol to the composition. A polyol of the present invention is a polyhydric alcohol. The polyol is preferably selected from the group comprising, glycerol, di-propylene glycol, mono-propylene glycol, pentaerythritol, hexyleneglycol, glucose, sorbitol, sucrose, maltose and combinations thereof. More preferably, the polyol is selected from the group comprising glycerol, di-propylene glycol, mono-propylene glycol and combinations thereof. Most preferably, the polyol is selected from the group comprising, glycerol, mono-propylene glycol and combinations thereof.

In one embodiment, the polyol level is in the range from 0.005% to 15%, preferably from 0.005% to 10%, more preferably from 0.005% to 5%.

### 5. Adjunct Materials

According to another aspect of the present invention, the fabric softening compositions may comprise one or more of the following optional ingredients: perfumes, encapsulated perfumes, dispersing agents, stabilizers, pH control agents, colorants, brighteners, dyes, odor control agent, pro-perfumes, cyclodextrin, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, thickeners, chelants, electrolytes and mixtures thereof. These ingredients are described in further detail in U.S. Pat. Pub. No. US 2003/0060390 at paragraphs 123-222.

### 6. Processing

The composition of the present invention can be prepared using processes known to those skilled in the art. These include processes previously described in WO99/29823, Demeyere et al., published Jun. 17, 1999, on page 26, last paragraph entitled ‘Process’ and also page 27, lines 1-19. Preferably, the present invention can be prepared by a process comprising the steps of;
a) mixing and heating of the fabric softener active and/or other additives to form a melt;
b) dispensing the melt in water;
c) cooling the resulting dispersion to below the Krafft temperature of the softener active before adding other additives such as, non-ionic alkoxylated surfactants, polyols and silicone comprising compound and/or other ingredients;
   wherein the Krafft temperature (or critical micelle temperature), is the minimum temperature at which the fabric softener softener active forms vesicules/micelles.

### 7. Physical Stability

One aspect of the present invention is based on the surprising discovery that the composition of the present invention remains physically stable following a freeze-thaw cycle and upon prolonged storage at low temperatures. In the context of the present invention, physical stability can be described as commercially acceptable viscosity. Commercially acceptable viscosity in the context of the present invention is below 0.5 m⁻¹. kg.s⁻¹. Following a freeze-thaw cycle or upon prolonged storage at low temperatures, there is a gelling, or thickening of the composition, which results in an increase in viscosity. In traditional fabric softening compositions, this gelling or thickening is an irreversible process which results in poor dispersibility into the wash liquor, uneven deposition onto fabrics, spotting, and sticking of residual composition to the washing machine dispenser drawer.

The term “freeze-thaw cycle” in the context of the present invention means 0.175 l of the fabric softening composition of the present invention is exposed to one or more cycles of a first step at −18° C. for 24 hours followed by a second step of +20° C. for 24 hours.

In one embodiment the composition when tested immediately following a freeze-thaw cycle comprising a first step at −18° C. for 24 hours followed by a second step at +20° C. for 24 hours, has a viscosity of less than 0.5 m⁻¹. kg.s⁻¹, more preferably below 0.3 m⁻¹. kg.s⁻¹, and most preferably below 0.2 m⁻¹. kg.s⁻¹.

For the purposes of the present invention, the viscosities of the compositions are measured with a Brookfield® viscometer, using a no 2 spindle at 25° C.

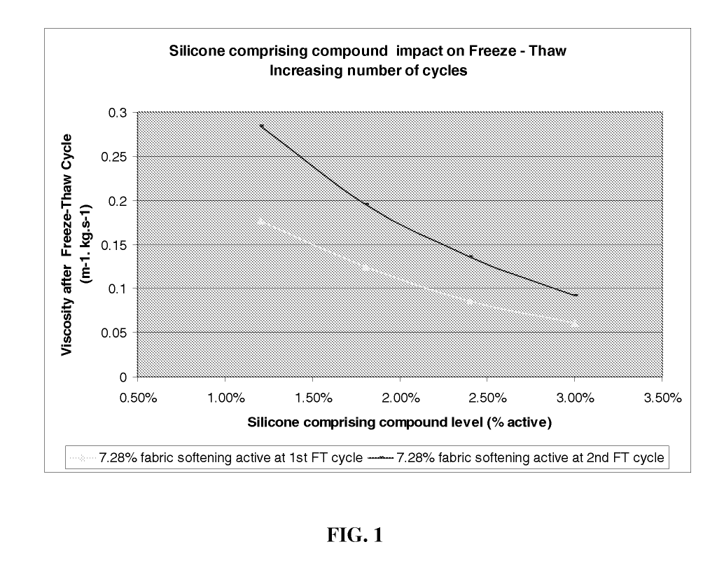

FIG. 1 is a graph showing the positive impact of increasing the levels of silicone comprising compounds on the maintenance of physical stability of the fabric softening composition following a freeze-thaw cycle; i.e. at fixed fabric softener active, non-ionic alkoxylated surfactant and polyol levels, product viscosity is seen to decrease as the level of silicone increases. Particularly, it shows that silicone comprising compounds continue to maintain physical stability upon increasing numbers of freeze-thaw cycles.

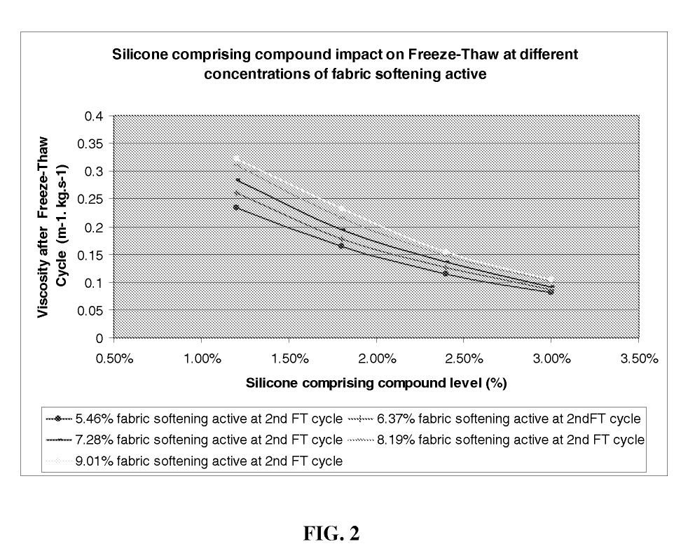

FIG. 2 is a graph showing the positive impact of increasing the level of silicone comprising compounds on maintenance of physical stability following a freeze-thaw cycle; i.e. at different fabric softener active concentrations and at fixed levels of non-ionic alkoxylated surfactant and polyol, product viscosity is seen to decrease as the level of silicone increases.

### 8. Methods of Use

One aspect of the present invention, is the use of the fabric softening composition of the present invention as a composition that maintains physical stability following a freeze-thaw cycle or upon prolonged storage at low temperatures.

In another aspect, the use of the fabric softening composition of the present invention as a composition that when tested immediately following a freeze-thaw cycle comprising a first step at −18° C. for 24 hours followed by a second step at +20° C. for 24 hours, has a viscosity of less than 0.5 m⁻¹. kg.s⁻¹.

In yet another aspect, the use of a silicone comprising compound to help maintain the viscosity of a fabric softening composition comprising a silicone comprising compound below 0.5 m⁻¹. kg.s⁻¹, immediately following a freeze-thaw cycle.

In a further aspect of the present invention, the method of use of the composition of the present invention, comprising the step of dosing the composition in a rinse step of a washing process.

### 9. Examples

The following are non-limiting examples of the present invention. Percentages are expressed as percentage by weight of the composition.

| | Examples | | | | | | |
|---|---|---|---|---|---|---|---|
| INGREDIENTS | I | II | III | IV | V | VI | V |
| Fabric softening | 5.67% | 6.22% | 6.22% | 7.00% | 7.00% | 7.44% | 8.9% |
| active^{a} | | | | | | | |
| Silicone | 1.14% | 1.26% | 1.26% | 2.00% | 2.00% | 3.0% | 3.0% |
| comprising | | | | | | | |
| compound^{b} | | | | | | | |
| CAE10^{c} | 0.60% | 0.60% | 0.60% | 0.60% | 0.60% | 0.33% | 0.22% |
| MPG^{d} | 0.00% | 1.74% | 3.45% | 1.94% | 3.88% | 5.00% | 1.81% |
| Glycerol | 5.00% | 5.00% | 5.00% | 5.00% | 5.00% | 5.00% | 0.77% |
| Perfume | 0.60% | 0.60% | 0.60% | 0.60% | 0.60% | 0.60% | 0.60% |
| Perfume | 0.25% | 0.25% | 0.25% | 0.25% | 0.25% | 0.25% | 0.25% |
| microcapsule | | | | | | | |
| Preservative | 0.0075% | 0.0075% | 0.0075% | 0.0075% | 0.0075% | 0.0075% | 0.0075% |
| Structurant | 0.11% | 0.15% | 0.15% | 0.2% | 0.2% | 0.2% | 0.2% |
| Calcium | 0.05% | 0.05% | 0.05% | 0.05% | 0.05% | 0.05% | 0.05% |
| chloride | | | | | | | |
| Vitasyn Blue | 0.00028% | 0.00028% | 0.00028% | 0.00028% | 0.00028% | 0.00028% | 0.00028% |
| Dye | | | | | | | |
| Sanolin Violet | 0.00052% | 0.00052% | 0.00052% | 0.00052% | 0.00052% | 0.00052% | 0.00052% |
| Dye | | | | | | | |
| Formic acid | 0.025% | 0.025% | 0.025% | 0.025% | 0.025% | 0.025% | 0.025% |
| Deionized water | Balance | Balance | Balance | Balance | Balance | Balance | Balance |

^{a}N,N-di(tallowoyloxyethyl)-N,N-dimethylammonium chloride,
^{b}Silicone comprising compound, available under the trade name SM2169 supplied by Momentive
^{c}Non ionic surfactant - C12/14 Alcohol Ethoxylate
^{d}Mono-propylene glycol

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric softening composition comprising;
a fabric softening active selected from the group comprising, diester quaternary ammonium compounds, dialkyl quaternary ammonium compounds, imidazolinium quaternary compounds, cationic starch, sucrose ester-based fabric care materials, and mixtures thereof;
about 0.5% to about 10% by weight of the fabric softening composition of a silicone comprising compound, wherein the silicone comprising compound is polydimethyl silicone;
about 0.005% to about 4% by weight of the fabric softening composition of a non-ionic alkoxylated surfactant;
about 0.005% to about 15% by weight of the fabric softening composition of a polyol.

2. The fabric softening composition of claim 1, wherein the silicone comprising compound is from about 0.3% to about 10%, by weight of the fabric softening composition.

3. The fabric softening composition of claim 2, wherein the silicone comprising compound is added as an emulsion of the silicone comprising compound in a solvent.

4. The fabric softening composition of claim 3, wherein the solvent is selected from the group comprising C1-C20 linear, branched, cyclic, saturated and/or unsaturated alcohols with one or more free hydroxy groups; amines, alkanolamines, and mixtures thereof.

5. The fabric softening composition of claim 1, wherein the polydimethyl silicone has a viscosity between about 0.0001 m².s⁻¹ and about 0.1 m².s⁻¹

6. The fabric softening composition of claim 1, wherein the non-ionic alkoxylated surfactant is from about 0.1% to about 2%, by weight of the fabric softening composition.

7. The fabric softening composition of claim 6, wherein the non-ionic alkoxylated surfactant is an alcohol alkoxylate.

8. The fabric softening composition of claim 7, wherein the polyol is from about 0.005% to about 10%, by weight of the fabric softening composition.

9. The fabric softening composition of claim 8, wherein the polyol is selected from the group comprising, glycerol, di-propylene glycol, mono-propylene glycol, pentaerythritol, hexyleneglycol, glucose, sorbitol, sucrose, maltose and combinations thereof.

10. The fabric softening composition of claim 9, wherein the polyol is selected from the group comprising, glycerol, mono-propylene glycol and combinations thereof.

11. The use of a fabric softening composition comprising;
a fabric softening active selected from the group comprising, diester quaternary ammonium compounds, dialkyl quaternary ammonium compounds, imidazolinium quaternary compounds, cationic starch, sucrose ester-based fabric care materials, and mixtures thereof;
about 0.5% to about 10% by weight of the fabric softening composition of a silicone comprising compound, wherein the silicone comprising compound is polydimethyl silicone;
about 0.005% to about 4% by weight of the fabric softening composition of a non-ionic alkoxylated surfactant;
about 0.005% to about 15% by weight of the fabric softening composition of a polyol;
as a composition that when tested immediately following a freeze-thaw cycle comprising a first step at −18° C. for 24 hours followed by a second step at +20° C. for 24 hours, has a viscosity of less than about 0.5 m⁻¹. kg.s⁻¹.

12. The method of use of a fabric softening composition comprising;
a fabric softening active selected from the group comprising, diester quaternary ammonium compounds, dialkyl quaternary ammonium compounds, imidazolinium quaternary compounds, cationic starch, sucrose ester-based fabric care materials, and mixtures thereof;
about 0.5% to about 10% by weight of the fabric softening composition of a silicone comprising compound, wherein the silicone comprising compound is polydimethyl silicone;
about 0.005% to about 4% by weight of the fabric softening composition of a non-ionic alkoxylated surfactant;
about 0.005% to about 15% by weight of the fabric softening composition of a polyol;
comprising the step of dosing the composition in a rinse step of a washing process.
